(19) United States
(12) Patent Application Publication
(10) Pub. No.: US 2014/0025421 A1
(43) Pub. Date: Jan. 23, 2014

(54) ON-LINE SYSTEM, METHOD AND COMPUTER PROGRAM PRODUCT FOR MATCHING EVENT VENDORS WITH EVENT PLANNERS IN REAL-TIME

(71) Applicant: Nayana Sen, St. Augustine, FL (US)

(72) Inventor: Nayana Sen, St. Augustine, FL (US)

(21) Appl. No.: 14/032,745

(22) Filed: Sep. 20, 2013

Related U.S. Application Data
(63) Continuation-in-part of application No. 13/590,580, filed on Aug. 21, 2012, now abandoned.
(60) Provisional application No. 61/525,989, filed on Aug. 22, 2011.

(51) Int. Cl. G06Q 10/06

(52) U.S. Cl. CPC G06Q 10/06313
USPC 705/7.23

(57) ABSTRACT

A system, method and computer program product facilitates an online wedding planning system that automatically matches, in real-time, an event planner with event vendors. Exemplary steps include: receiving a first group of operating parameters for the event vendors; receiving a second group of operating parameters for the event planner; assigning a pro-rata percentage of the total budget to each of the event vendors; creating a qualified list of the event vendors wherein a sum of each the pro-rata percentage of the total budget is equal to or less than an associated maximum pro-rata percentage of the total budget of the event; and simultaneously displaying, in real-time, on a single graphical user interface of a web browser, the qualified list of the event vendors whose combined individual pro-rata percentage of the total budget is cumulatively equal to or less than the total budget of the event.

### CROSS REFERENCE TO RELATED APPLICATIONS

This application is a continuation-in-part application of U.S. patent application Ser. No. 13/590,580, filed Aug. 21, 2012 and currently pending, which claims the benefit of U.S. Provisional Application No. 61/525,989, filed Aug. 22, 2011, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE DISCLOSURE

1. Technical Field

This disclosure relates generally to the field of internet marketing and more specifically to a system, method and computer program product for matching event vendors with event planners in real-time.

2. Prior Art

Event planning for major events such as weddings or even milestone birthdays require a significant amount of planning and coordination by an event planner with vendors that meet their needs. Details may require multiple phone calls or emails to check availability of vendors, followed by questions related to cost. Weddings are often planned by professional planners who charge to conduct these errands on behalf of the bride or bride's may plan the wedding themselves with the aid of online tools.

These methods are time consuming for the event planner and frustrating for the wedding vendor that is trying to sell a service. Event vendors must be able to earn money by booking brides; however a good portion of their time is dedicated to simply answering basic questions for event planners that may or may not result in a sale.

There are several websites that provide event vendor information and a search on any major search engine under the term “online wedding planning” will show such results. These websites essentially function as an online magazine, showing static or non-changing information to all parties. Other wedding planning websites offer some form of interactive tools such as budget tracker, guest list, or even personalized webpages.

These other disclosures are only similar to the current disclosure in that these websites offer brides with wedding related information and offer the bride a method to expedite the wedding planning process.

Prior technology requires the bride or the planner to contact the vendor individually to find out if they are available on a specific date or check calendars individually.

Information presented is the same for all potential consumers, i.e. all brides will see the same information at the onset such as price. The current methodology does not take into account that vendors may be negotiable on price or a discount may be available on certain days or that they may charge different amounts for less experienced staff. There is no significant reduction of time for the bride or event planner using these other systems in terms of searching for vendors and identifying which vendors can best serve their needs.

Accordingly, a need remains for an automated on-line wedding event planner in order to overcome the above-noted shortcomings. The present disclosure satisfies such a need by providing a system, method and computer program product for matching event vendors with event planners in real-time that is convenient and easy to use, versatile in its applications, and provides a real-time internet portal for matching wedding vendors and wedding event planners.

### BRIEF SUMMARY OF THE DISCLOSURE

In view of the foregoing background, it is therefore an object of the present disclosure to provide a system, method and computer program product for matching event vendors with event planners in real-time. These and other objects, features, and advantages of the disclosure are provided by a website portal, which event vendors can utilize to create customized data that would allow a business to target event planners based on date of event, as well as budget and location.

Another object of the disclosure is to provide a system for advantageously enabling event planners to significantly reduce the amount of time needed to interact with multiple vendors across multiple categories for events that require that level of participation, such as weddings.

Another object of the disclosure is to provide a system enabling event vendors to update their information as often as needed, so the event planner will see information in real-time.

A further object of the disclosure is to provide a system enabling event vendors to provide information without being online or by the phone.

Yet another object of the disclosure is to provide a system that gives the event vendor a way to create an automated referral system.

In accordance with a preferred embodiment of the disclosure, there is disclosed A System and Database for matching event vendors with event planners in real-time comprising the steps of: a server having a memory configured to store data and instructions , a database stored in the memory and accessed by vendors and event planners through an internet website and, a processor associated with the server and configured to execute instructions to: receive and store in the database profiles of a plurality of vendors, including a location of each vendor, one or more categories of services offered by each vendor, and charges for the services of each vendor, receive and store in the database criteria of a planner of an event, including a date, time and place of the event, a budget for the event, a number of guests, and categories, Method, in response to the profile of the planner, access the database and match the planner with at least one vendor having a profile that meets at least one criteria of the planner, output to the planner a list of the at least one matching vendor, including vendors that are available at the time of the event, receive an input from the planner indicating one or more vendors the event planner would like to obtain more information from, receive an input from the planner indicating whether the planner will accept being contacted by selected vendors, and in response to the planner accepting contact by the selected vendors, transmit an e-mail notification to the selected vendors.

In accordance with a preferred embodiment of the disclosure, there is disclosed a method of determining availability for a plurality of vendors across multiple varying categories including a server having a memory configured to store data and instructions and a database stored in the memory and accessed by vendors and event planners through an internet website. comprising the steps of: inputting of a time block and date by vendor in main profile or any subsequent sub-profile indicating when a service, product, or user is not available, inputting of date by event planner indicating when an event will occur, in response to the criteria of the planner, access the database and match the planner with at least one vendor that is available on the date requested in requested category, in response to the criteria of the planner, access the database and match the planner with at least one vendor that is available on said date in all categories selected by the planner simultaneously, output to the planner a list of at least one matching vendor by date in each category selected on separate tabs, in which event planner may select named tab to view results of search for each category.

In accordance with a preferred embodiment of the disclosure, there is disclosed a method of matching event vendors to event planners based on overall event budget through the use of a server having a memory configured to store data and instructions and a database stored in the memory and accessed by vendors and event planners through an internet website. comprising the steps of: inputting of a minimal acceptable amount by sub-profile or by main profile if vendor charges the same rate for all applicable services, in response to the overall budget of the planner, access the database and calculate a percentage of that overall budget that an event planner would expect to pay for a specific category, output to the planner a list of at least one matching vendor in response to the overall budget of the planner, that is matched based on probably expenses associated with an event.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the disclosure of the application, which is measured by the claims, nor is it intended to be limiting as to the scope of the disclosure in any way.

### BRIEF DESCRIPTION OF THE SEVERAL VIEWS OF THE DRAWING

The novel features believed to be characteristic of this disclosure are set forth with particularity in the appended claims. The disclosure itself, however, both as to its organization and method of operation, together with further objects and advantages thereof, may best be understood by reference to the following description taken in connection with the accompanying drawings in which:

FIG. 1 is a block diagram of an embodiment of a system of the present disclosure for matching event planners with event vendors;

FIG. 2 is a flow chart of an embodiment of a method of the present disclosure that may be used by a bride-to-be to access the system of FIG. 1;

FIG. 3 is a flow chart of an embodiment of a method of the present disclosure that may be used by vendors to establish profiles in the system of FIG. 1;

FIG. 4 is an exemplary website screen shot listing categories of vendor services;

FIG. 5 is a flow chart of a process implemented by the present disclosure;

FIG. 6 is an exemplary step of the process implemented by the present disclosure;

FIG. 7 is an exemplary step of the process implemented by the present disclosure;

FIG. 8 is an exemplary website screen shot showing alternate vendors associated with a corresponding total budget of the event being planned by the bride or event planner;

FIG. 9 is an exemplary “home” website screen shot employed by the present disclosure;

FIG. 10 is an exemplary “registration” website screen shot employed by the present disclosure;

FIG. 11 is an exemplary “confirmation” website screen shot employed by the present disclosure;

FIG. 12 is an exemplary “login” website screen shot employed by the present disclosure;

FIG. 13 is an exemplary “welcome” website screen shot employed by the present disclosure;

FIG. 14 is an exemplary “vendor profile” website screen shot employed by the present disclosure;

FIG. 15 is an exemplary “vendor profile” website screen shot employed by the present disclosure wherein the vendor can select a type of service it wishes to offer;

FIG. 16 is an exemplary “vendor profile” website screen shot employed by the present disclosure wherein the vendor can further define its available services on a day of the wedding;

FIG. 17 is an exemplary “vendor profile” website screen shot employed by the present disclosure wherein the vendor can further define its available services on a day of the wedding;

FIG. 18 is an exemplary “vendor profile” website screen shot employed by the present disclosure wherein the vendor can provide further information about its geographic location;

FIG. 19 is an exemplary “vendor profile” website screen shot employed by the present disclosure wherein the vendor can define its non-availability dates;

FIG. 20 is an exemplary “vendor profile” website screen shot employed by the present disclosure wherein the vendor's non-availability dates are listed for user review;

FIG. 21 is an exemplary “vendor profile” website screen shot employed by the present disclosure wherein the vendor's non-availability dates are listed for user review;

FIG. 22 is an exemplary “vendor profile” website screen shot employed by the present disclosure wherein the vendor lists a minimum acceptable amount for providing services at an event;

FIG. 23 is an exemplary “vendor profile” website screen shot employed by the present disclosure wherein the vendor's minimum acceptable service amounts are listed;

FIG. 24 is an exemplary “vendor profile” website screen shot employed by the present disclosure wherein the vendor's experience and specials discounts are entered;

FIG. 25 is an exemplary “vendor profile” website screen shot employed by the present disclosure wherein the vendor is reminded about payment before its account is activated;

FIG. 26 is an exemplary “bride profile” website screen shot employed by the present disclosure wherein the bride (e.g., user, event planner) can enter a wedding date;

FIG. 27 is an exemplary “bride profile” website screen shot employed by the present disclosure wherein a wedding profile information is entered;

FIG. 28 is an exemplary “bride profile” website screen shot employed by the present disclosure wherein additional wedding details are entered;

FIG. 29 is an exemplary “bride profile” website screen shot employed by the present disclosure wherein the wedding budget can be entered;

FIG. 30 is an exemplary “bride profile” website screen shot employed by the present disclosure wherein the user can select a wedding category for finding an associated vendor;

FIG. 31 is an exemplary “bride profile” website screen shot employed by the present disclosure wherein wedding categories are listed;

FIG. 32 is a high-level diagram showing exemplary components of an exemplary computing device executing the software instructions employed by the present disclosure; and

FIG. 33 is an exemplary website screen shot employed by the present disclosure wherein the user can search available vendors from a plurality of search fields.

Those skilled in the art will appreciate that the figures are not intended to be drawn to any particular scale; nor are the figures intended to illustrate every embodiment of the disclosure. The disclosure is not limited to the exemplary embodiments depicted in the figures or the shapes, relative sizes or proportions shown in the figures.

### DETAILED DESCRIPTION OF THE DISCLOSURE

The present disclosure will now be described more fully hereinafter with reference to the accompanying drawings, in which a preferred embodiment of the disclosure is shown. This disclosure may, however, be embodied in many different forms and should not be construed as limited to the embodiment set forth herein. Rather, this embodiment is provided so that this application will be thorough and complete, and will fully convey the true scope of the disclosure to those skilled in the art. Like numbers refer to like elements throughout the figures.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “present disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The below disclosed subject matter is to be considered illustrative, and not restrictive, and the appended claims are intended to cover all such modifications, enhancements, and other embodiments which fall within the true scope of the present disclosure. Thus, to the maximum extent allowed by law, the scope of the present disclosure is to be determined by the broadest permissible interpretation of the following claims and their equivalents, and shall not be restricted or limited by the foregoing detailed description.

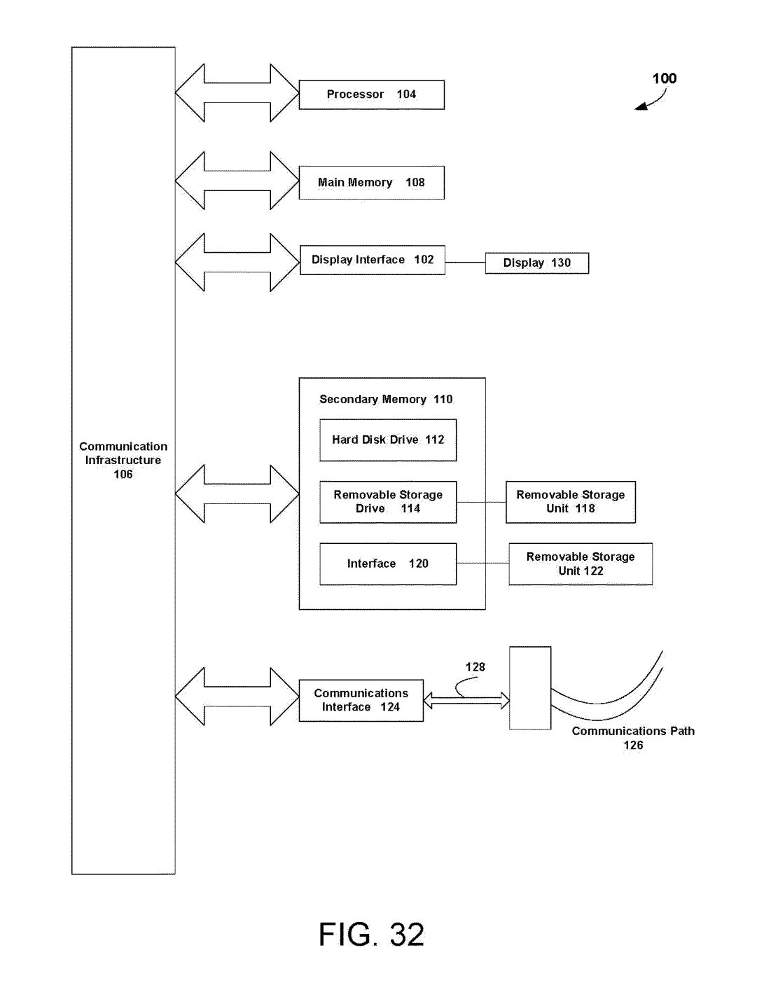

In one embodiment, the disclosure is directed toward one or more computer systems capable of carrying out the functionality described herein. An example of a computer system 100 is shown in FIG. 32.

Computer system 100 includes one or more processors, such as processor 104. The processor 104 is connected to a communication infrastructure 106 (e.g., a communications bus or network). Various software aspects are described in terms of this exemplary computer system. After reading this description, it will become apparent to a person skilled in the relevant art(s) how to implement the disclosure using other computer systems and/or architectures.

Computer system 100 can include a display interface 102 that forwards graphics, text and other data from the communication infrastructure 106 (or from a frame buffer not shown) for display on the display unit 130.

Computer system 100 also includes a main memory 108, preferably random access memory (RAM) and may also include a secondary memory 110. The secondary memory 110 may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well known manner. Removable storage unit 118 represents a floppy disk, magnetic tape, optical disk, etc. which is read by and written to by removable storage drive 114. As will be appreciated, the removable storage unit 118 includes a computer usable storage medium having stored therein computer software and/or data.

In alternative aspects, secondary memory 110 may include other similar devices for allowing computer programs or other code or instructions to be loaded into computer system 100. Such devices may include, for example, a removable storage unit 122 and an interface 120. Examples of such may include a program cartridge and cartridge interface (such as that found in video game devices), a removable memory chip (such as an erasable programmable read only memory (EPROM), or programmable read only memory (PROM)) and associated socket and other removable storage units 122 and interfaces 120, which allow software and data to be transferred from the removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124 are in the form of non-transitory signals 128 which may be electronic, electromagnetic, optical or other signals capable of being received by communications interface 124. These signals 128 are provided to communications interface 124 via a communications path (e.g., channel) 126. This channel 126 carries signals 128 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 114, a hard disk installed in hard disk drive 112 and signals 128. These computer program products provide software to computer system 100. The disclosure is directed to such computer program products.

Computer programs (also referred to as computer control logic) are stored in main memory 108 and/or secondary memory 110. Computer programs may also be received via communications interface 124. Such computer programs, when executed, enable the computer system 100 to perform the features of the present disclosure, as discussed herein. In particular, the computer programs, when executed, enable the processor 104 to perform the features of the present disclosure. Accordingly, such computer programs represent controllers of the computer system 100.

In an embodiment where the disclosure is implemented using software, the software may be stored in a computer program product and loaded into computer system 100 using removable storage drive 114, hard drive 112 or communications interface 124. The control logic (software), when executed by the processor 104, causes the processor 104 to perform the functions of the disclosure as described herein.

In another embodiment, the disclosure is implemented primarily in hardware using, for example, hardware components such as application specific integrated circuits (ASICs). Implementation of the hardware state machine so as to perform the functions described herein will be apparent to persons skilled in the relevant art(s).

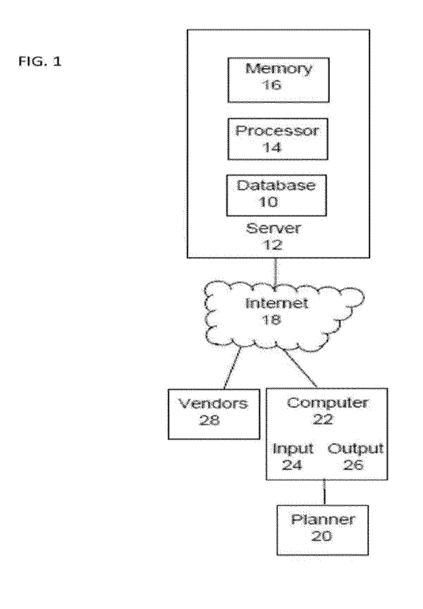

As will be apparent to one skilled in the relevant art(s) after reading the description herein, the computer architecture shown in FIG. 1 may be configured as any number of computing devices such as a game console, a portable media player, a desktop, a laptop, a server, a tablet computer, a PDA, a mobile computer, a smart telephone, a mobile telephone, an intelligent communications device or the like.

In yet another embodiment, the disclosure is implemented using a combination of both hardware and software.

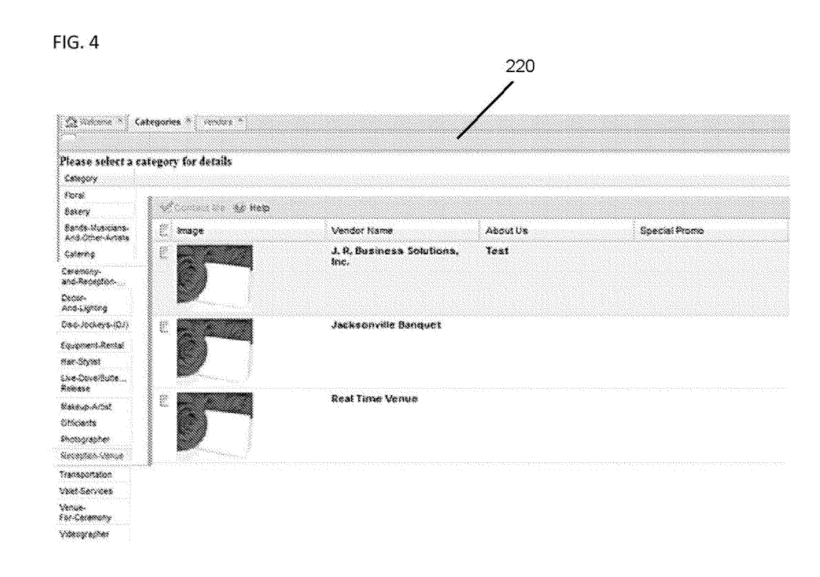

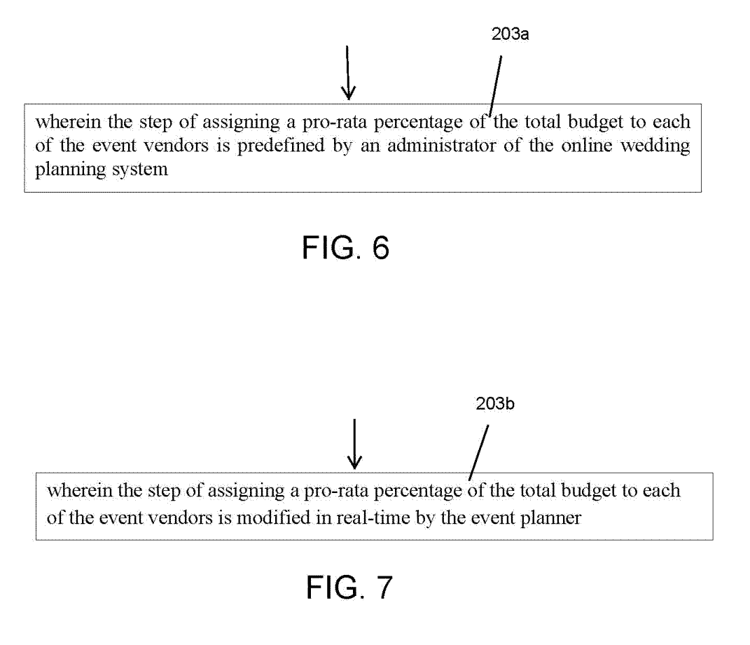

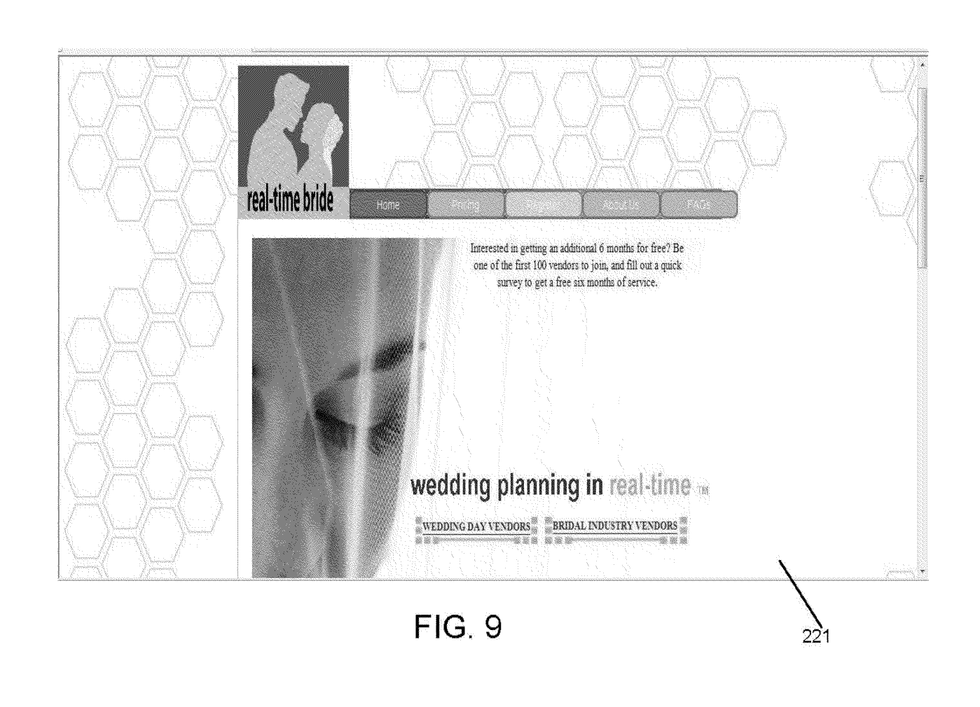

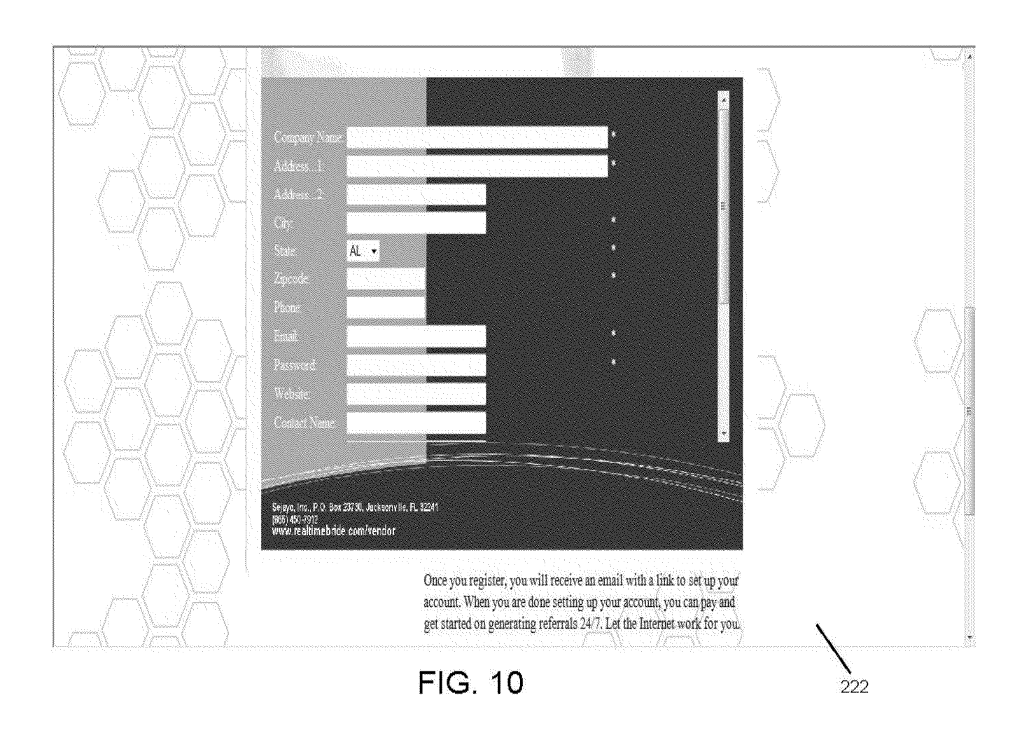

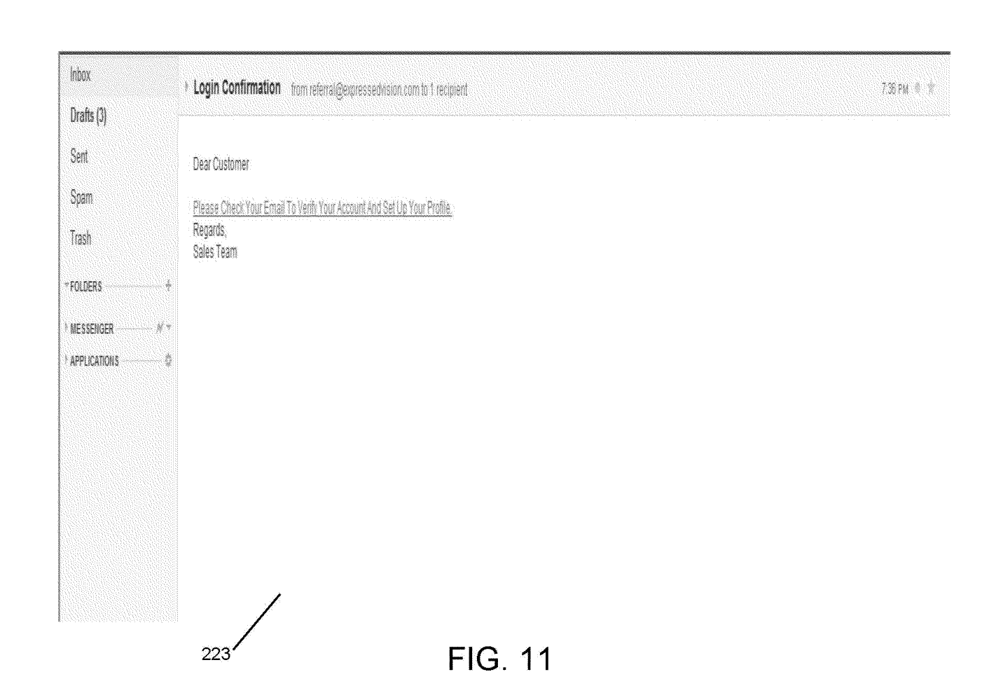

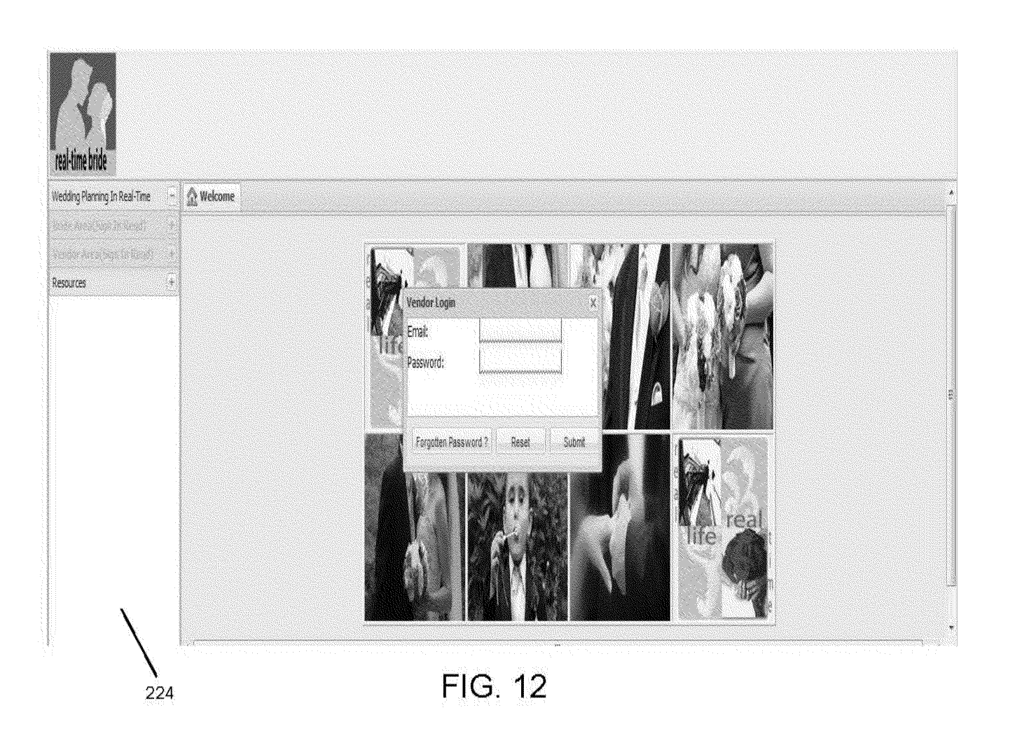

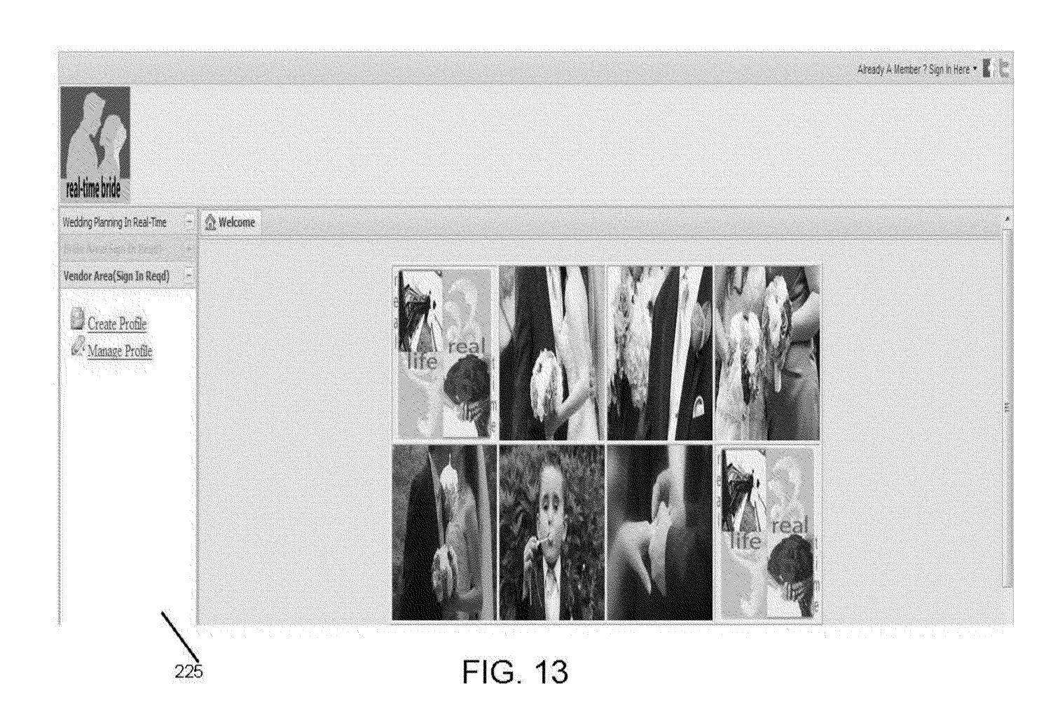

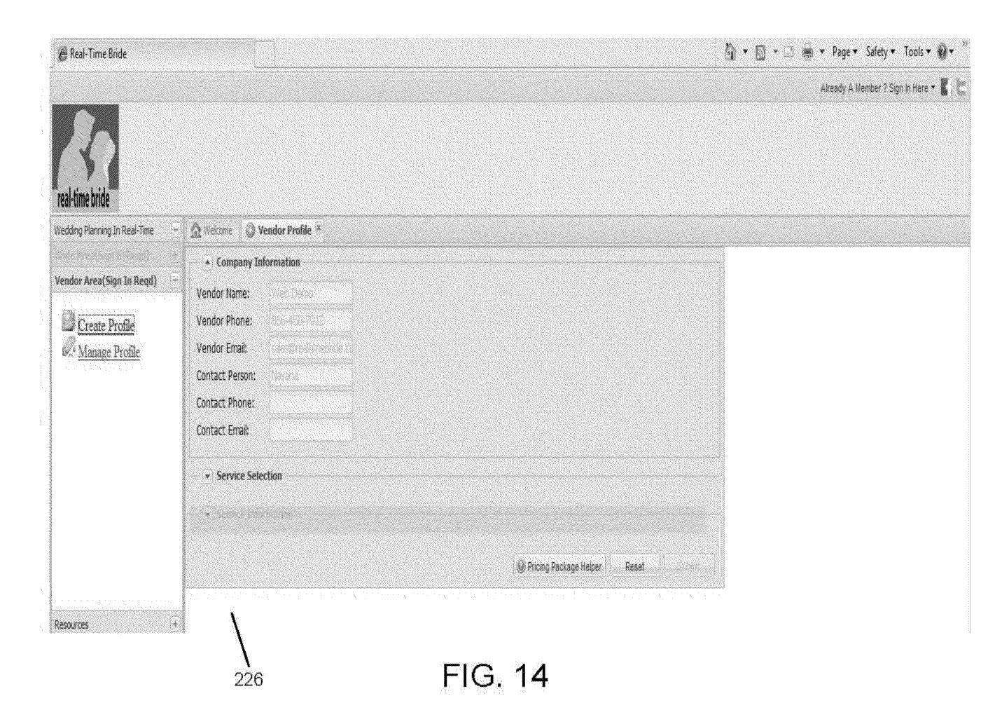

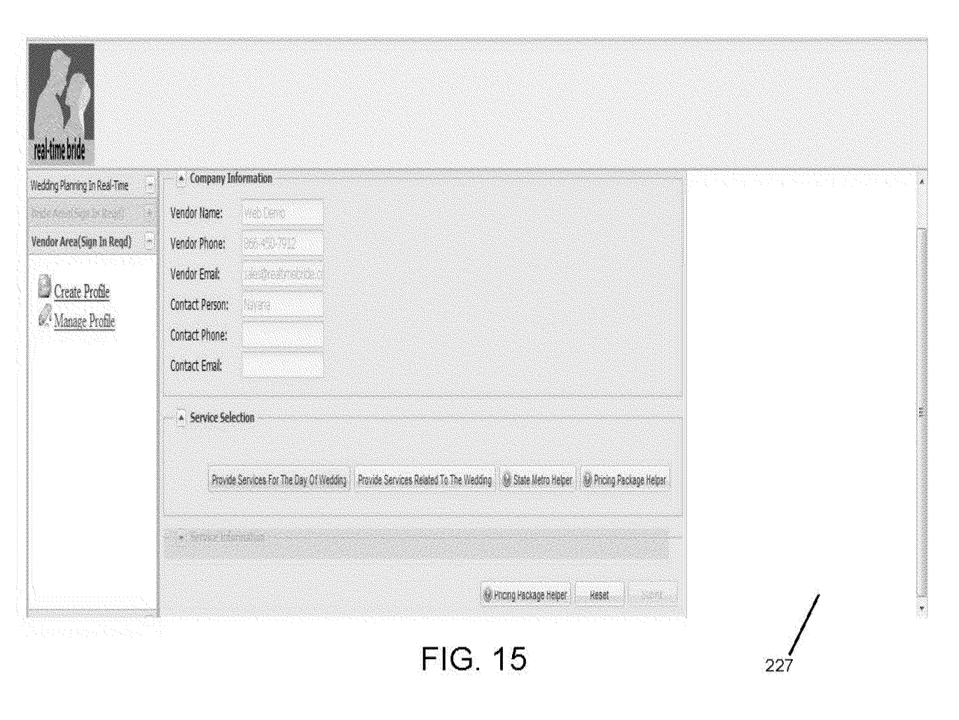

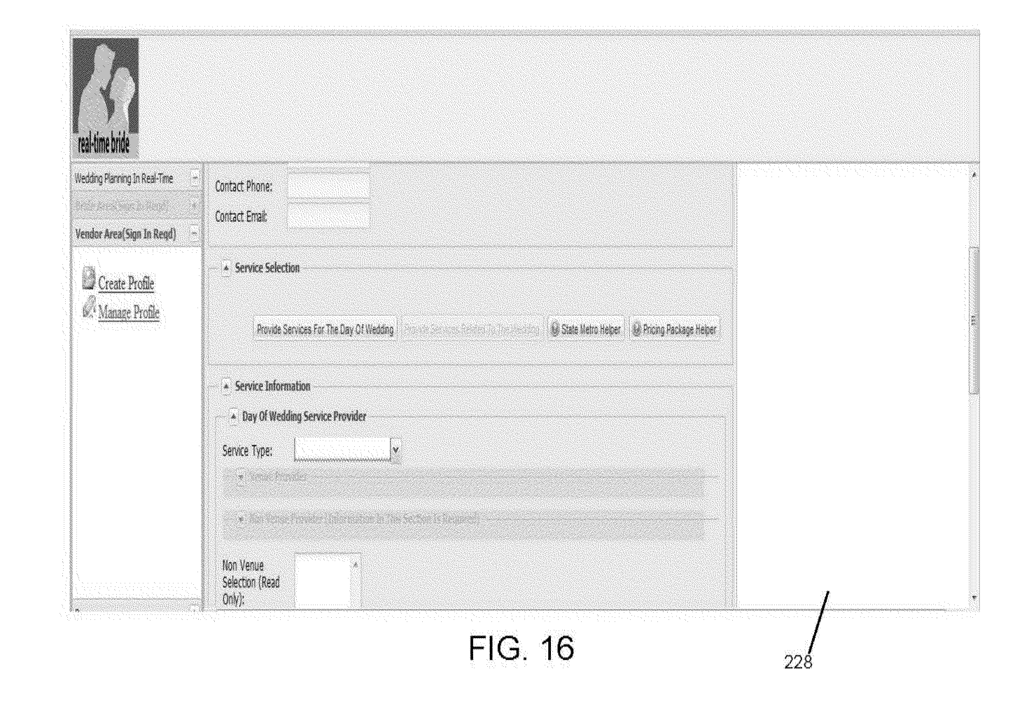

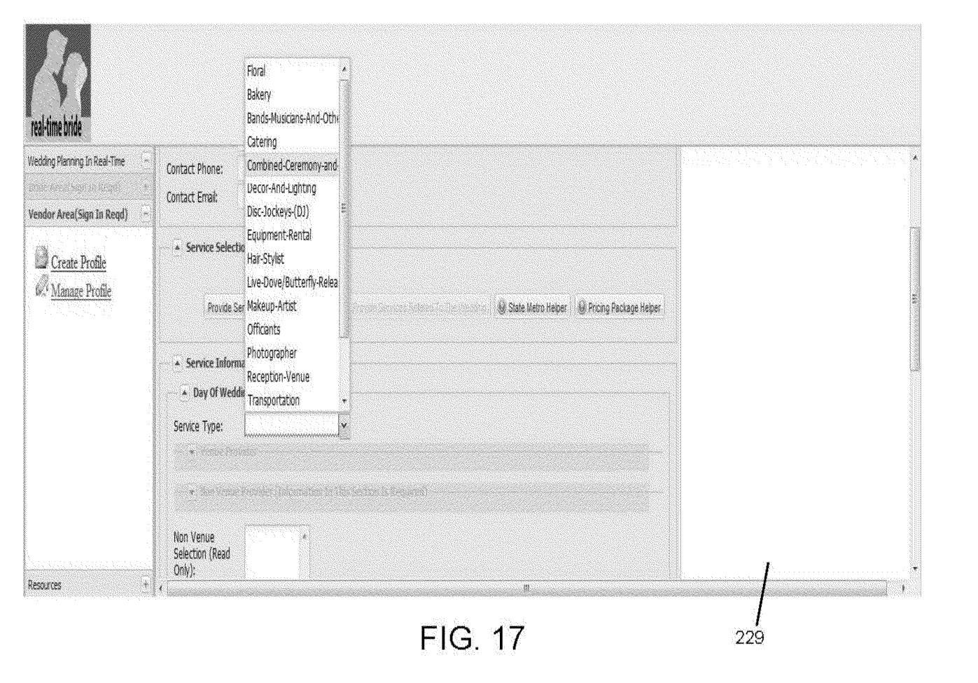

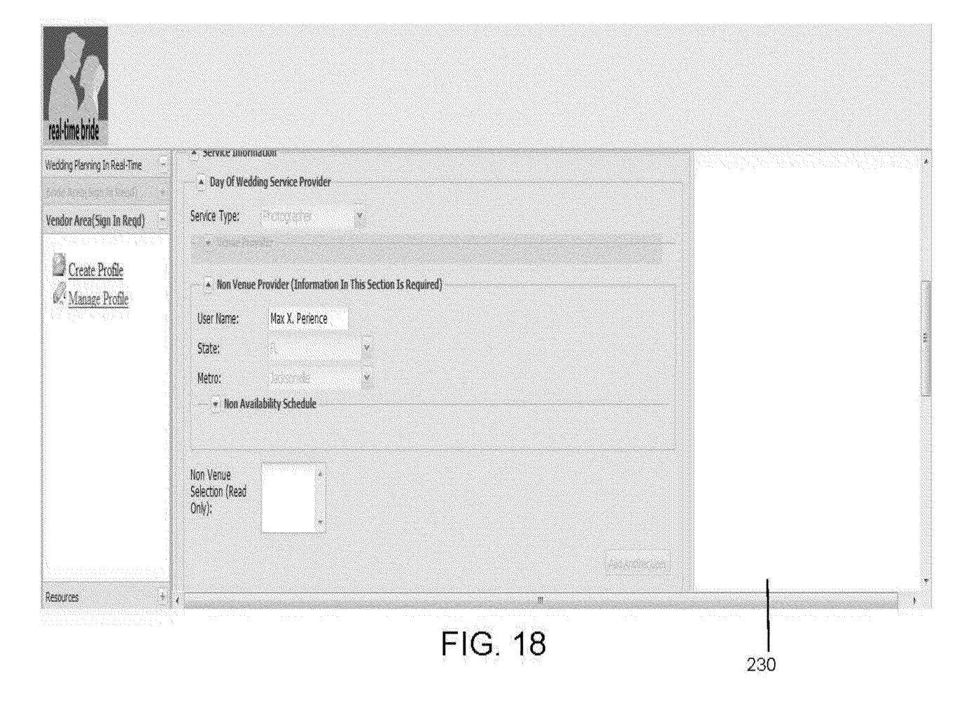

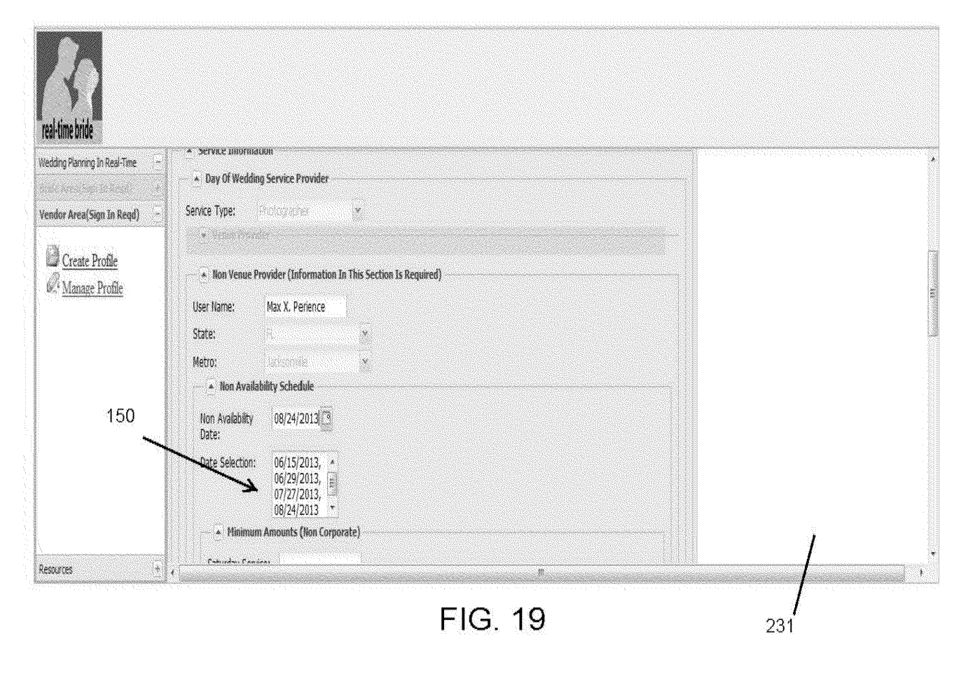

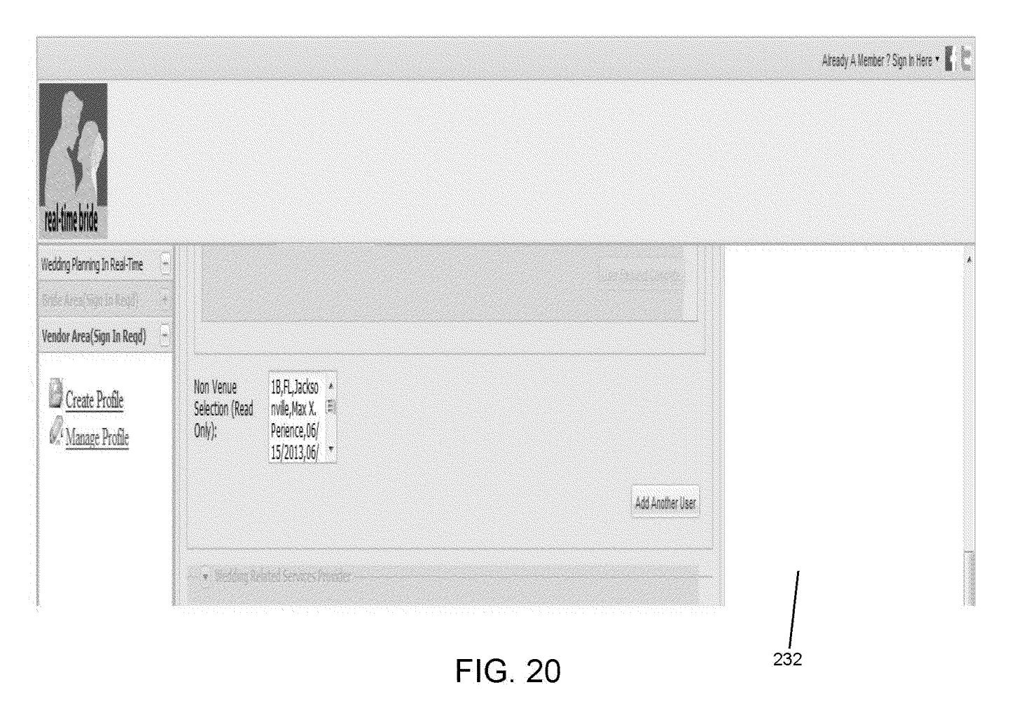

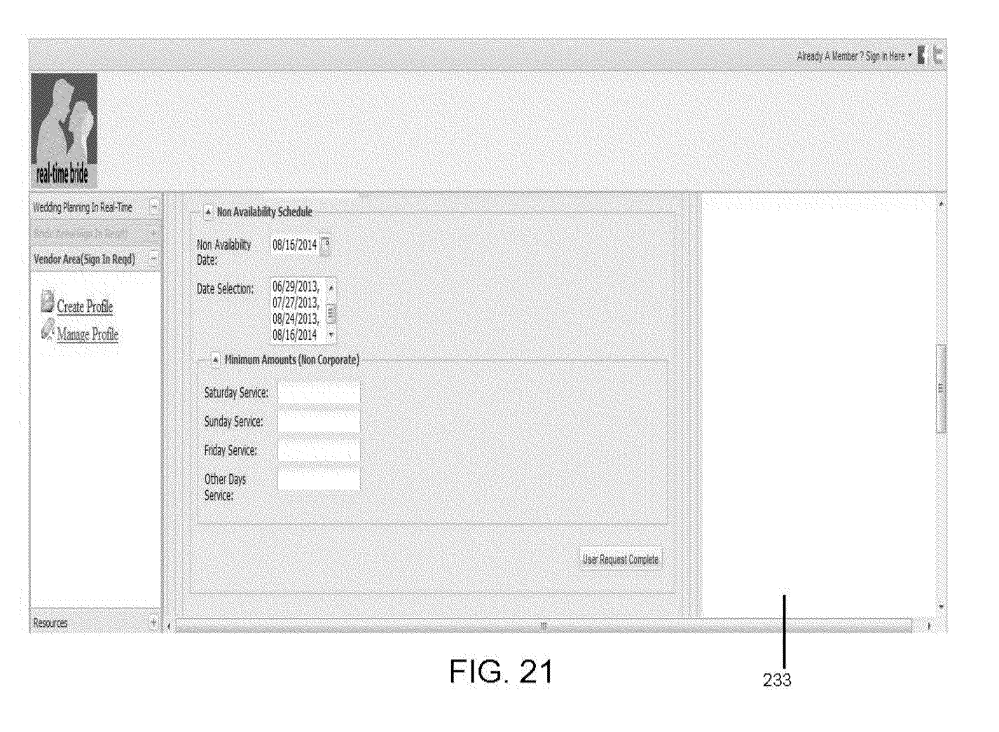

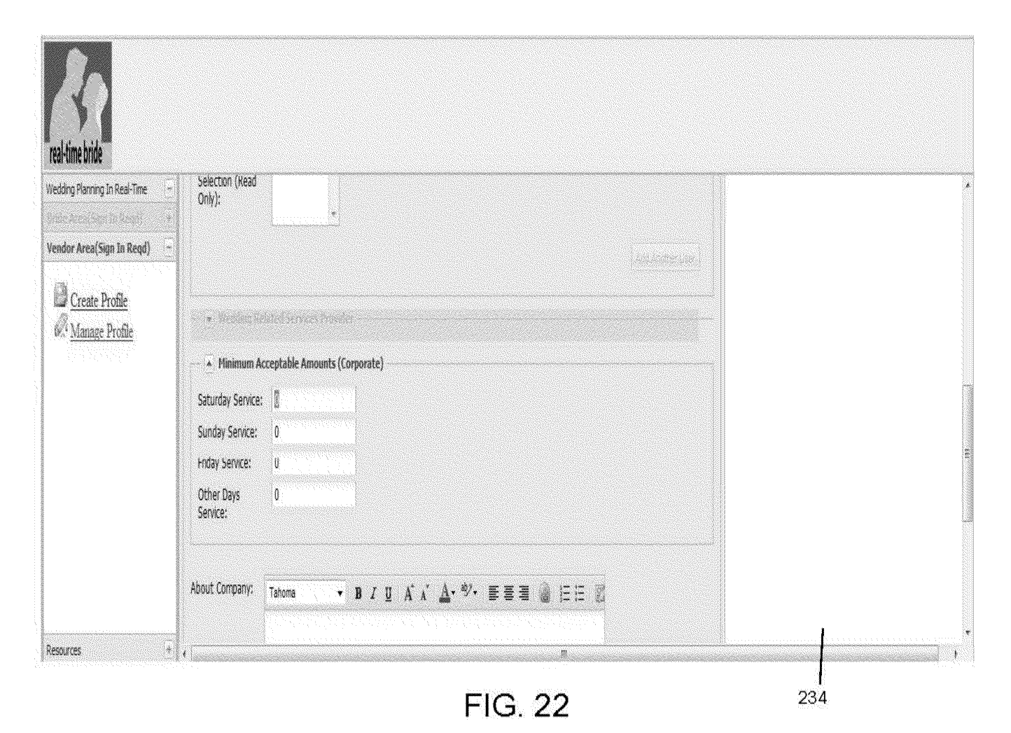

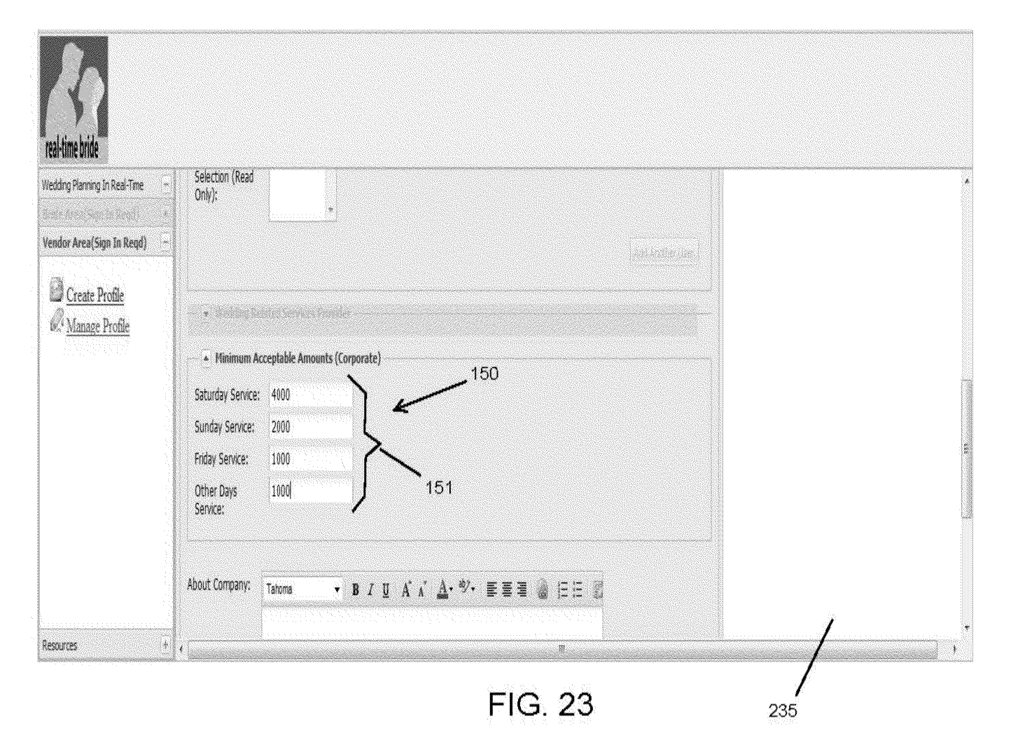

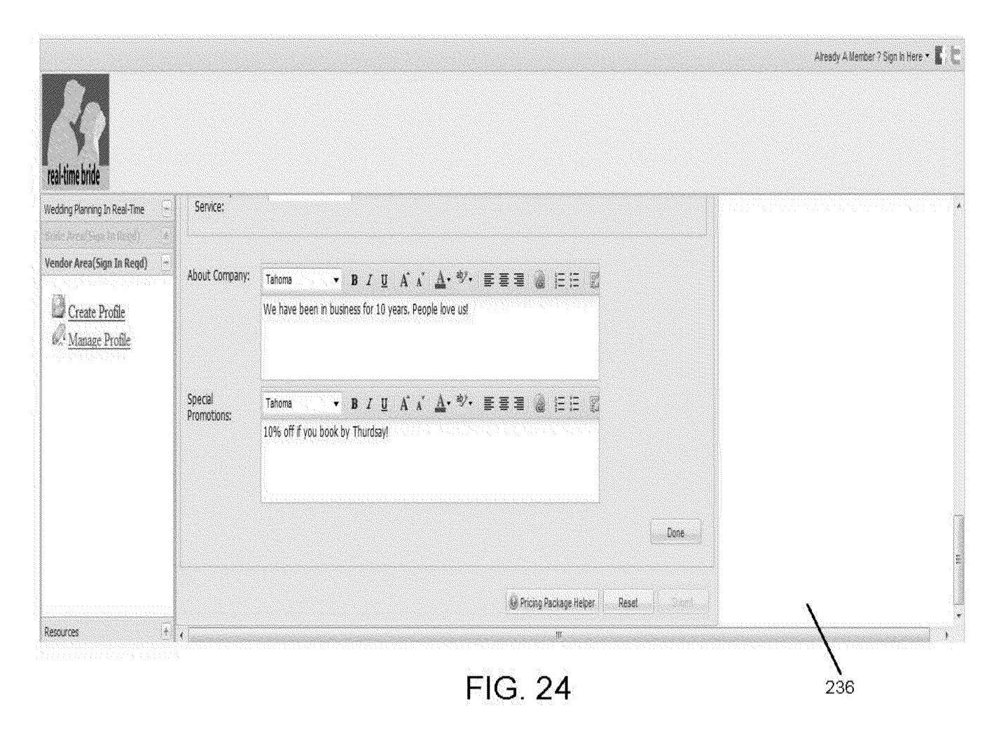

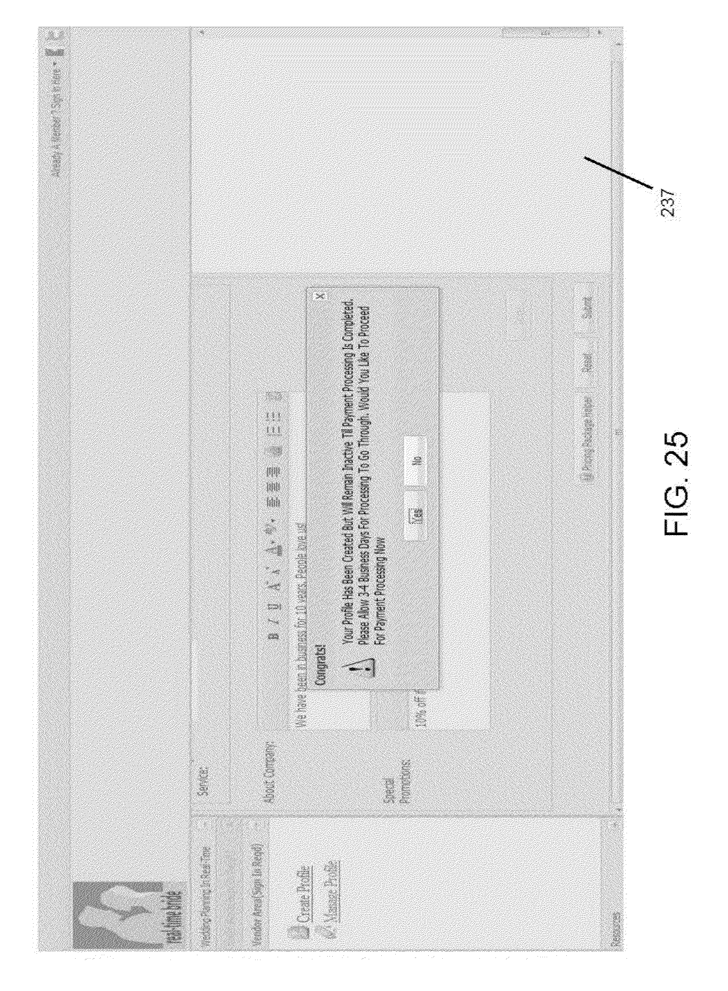

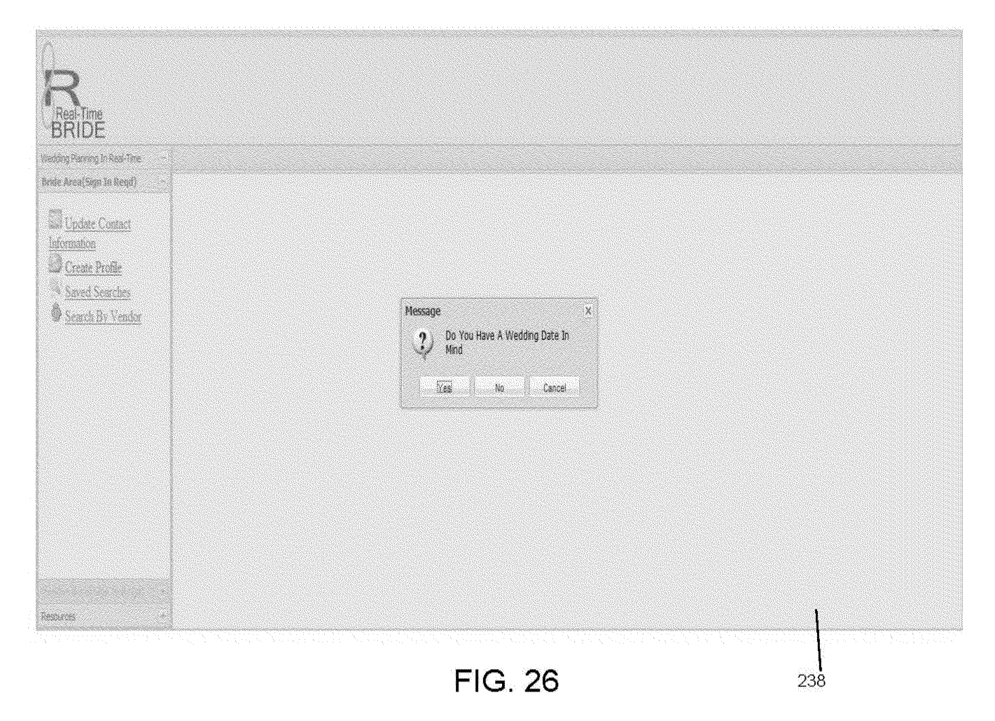

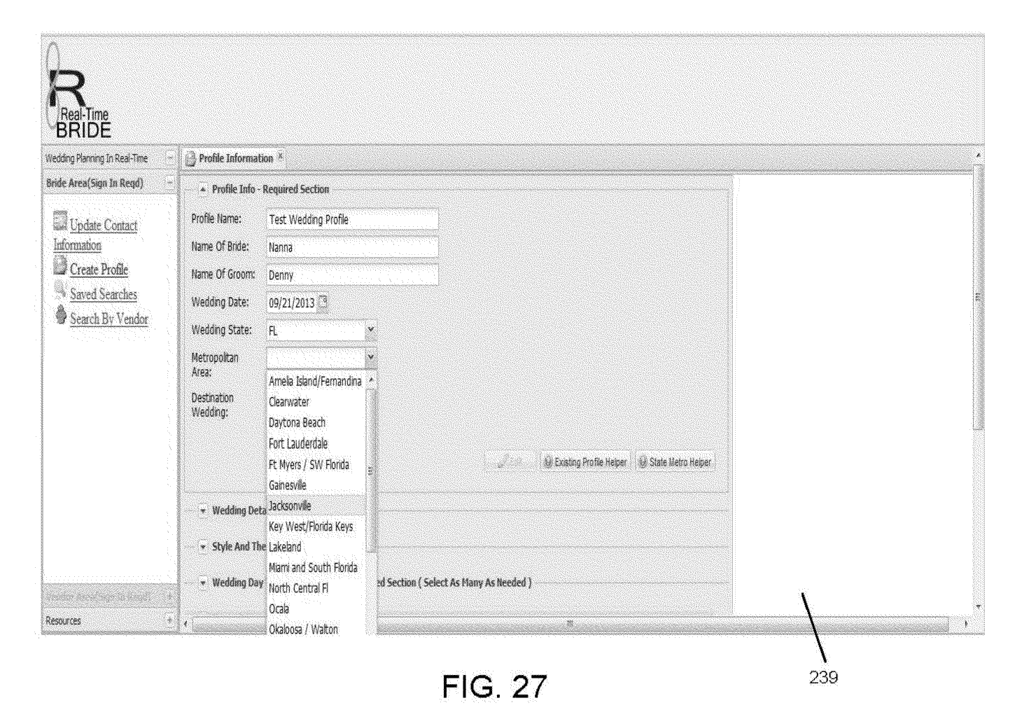

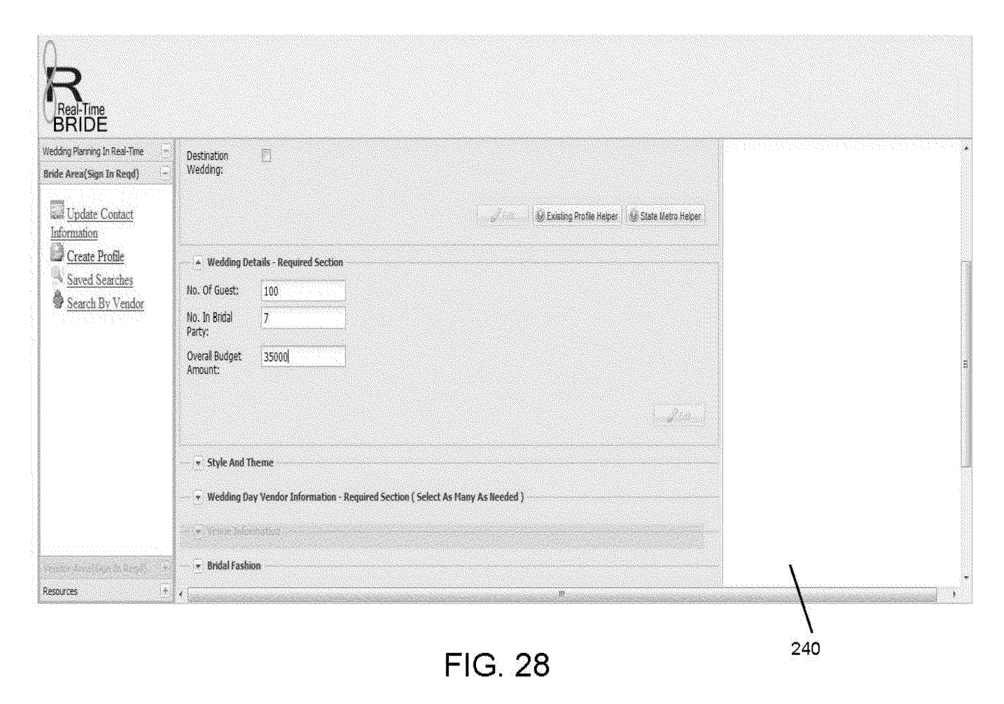

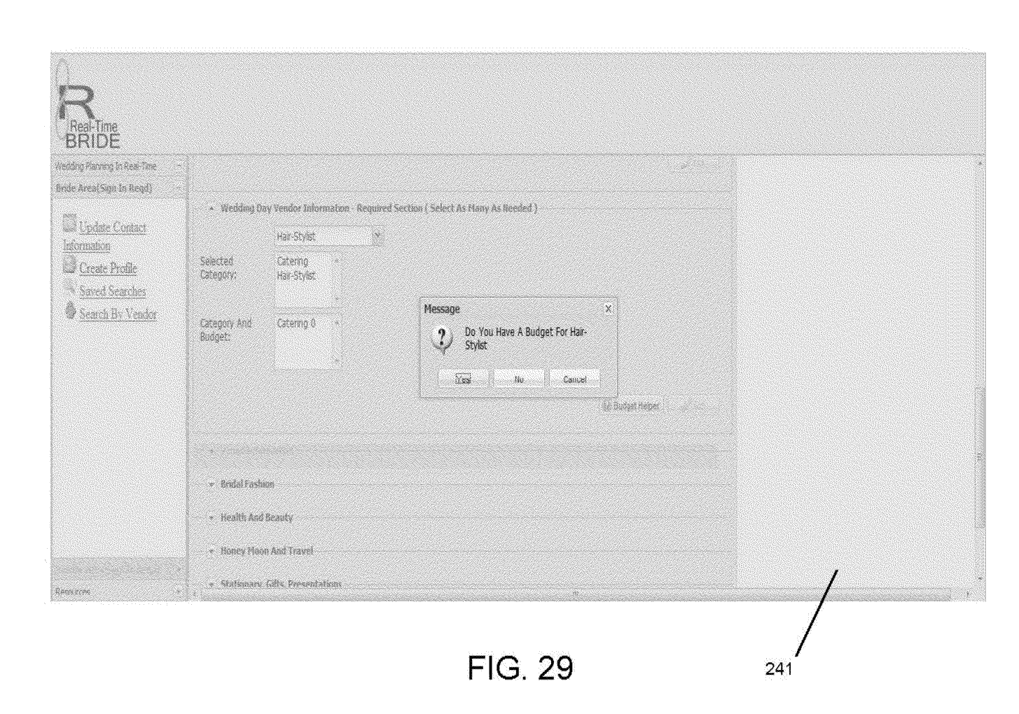

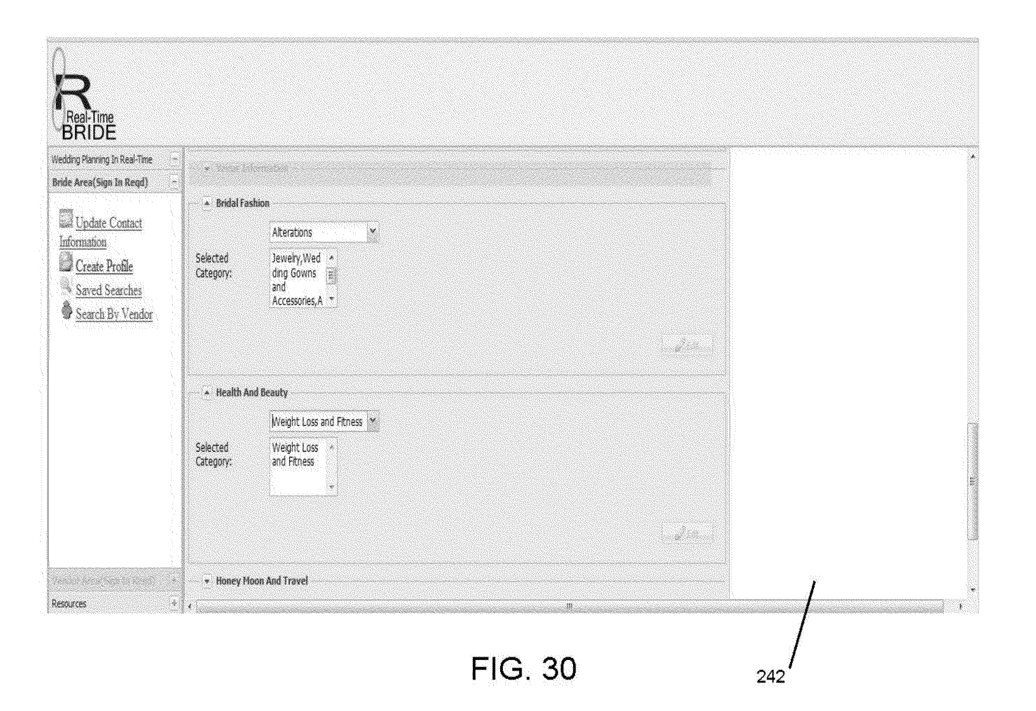

The disclosure is referred to generally in FIGS. 1-33 and is intended to provide a system, method and computer program product for matching event vendors with event planners in real-time. It should be understood that one or exemplary embodiments of the present disclosure may be used to match many different types of vendors with one or more event planners in real-time. For example, while a preferred embodiment is direct to an online wedding planning system, other types of planning systems may be employed by the present disclosure (e.g., birthday parties, graduation dinners, corporate events, sporting events, etc.)

Broadly, a non-limiting exemplary embodiment of the present disclosure generally provides a system, method and computer program product for matching event vendors with event planners, such as brides-to-be.

People who are planning an event, such as a bride-to-be planning a wedding, generally hire several or many vendors, such as a flower supplier, a dress maker, a food caterer, a photographer, and a facility, to name a few. Finding out which of several vendors of each type are available on the proposed event date and at the proposed time, and which meet the planner's budget, can be time consuming and tedious and may require that the planner contact vendors individually either by phone, email, or website interface to determine suitability and availability.

In a non-limiting exemplary embodiment, the system of the present disclosure may include a database 10 (FIG. 1) that may be stored and accessed through a server 12 or other computer. The server 12 may include a processor 14 and a memory 16 that may store the database and instructions executed by the processor 14, including instructions directed to accessing, managing, storing, outputting, and revising database entries. The server 12 may be connected to the internet 18 through which the database 10 may be accessed by an event planner 20 using a computer 22, also connected to the internet 18. Using any appropriate input 24 and output 26 devices, the planner 20 may enter information into, and receive information from, the database 10. Event vendors 28 may also access the database 10 through the internet 18.

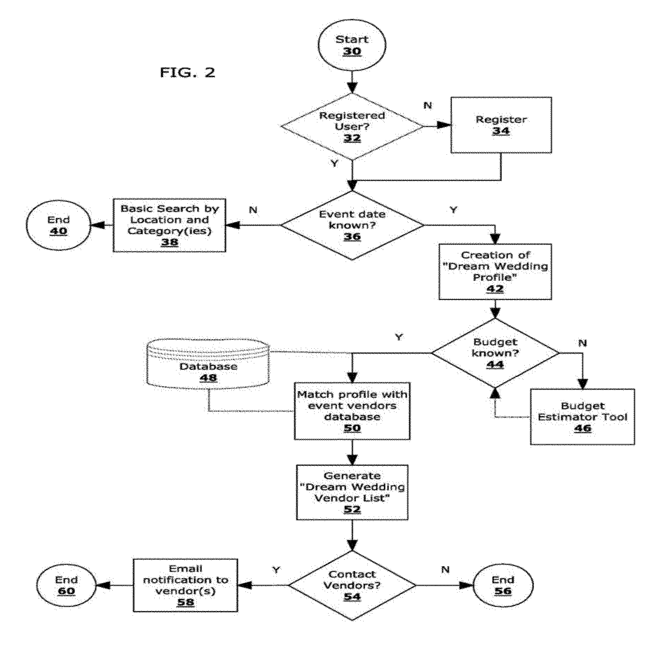

Although the figures and description refer to the present disclosure in the context of a bride-to-be planning a wedding, it will be appreciated that the present disclosure may be used for planning any other event in which a planner and event vendors may be matched such as, for example, a banquet, a party, a conference, etc. Referring to the flowchart of FIG. 2, a bride-to-be (or other event planner) 20 may visit an internet 18 website (step 30) to register (step 34) and gain access to the full services of the database 10. Alternatively, a bride 20 who visits the internet website 18 (at step 30) and previously registered may log in (step 32). If the event date is not known then a registered bride or other event planner 20 will be able to search for vendors by basic location and categories (step 38) and upon completion of the basic search may exit the website (step 40).

Alternatively, if the event date is known, then a bride or other event planner 20 may create a “dream wedding profile” (step 42). The bride or other event planner 20 will be prompted by the system, via a graphical user interface (GUI) to enter a budget amount (step 44). If a budget is not determined, then the system will help the bride or other event planner 20 estimate the budget to be used (step 46). All such information created as part of the bridal profile is saved and stored in the database (step 48). The bridal form may include such criteria as the names of the bride and groom, the wedding date and location, the number of guests, the number in the bridal party, the budgeted amount for the wedding, the style and theme for the wedding, including colors, venue information, and categories of vendors to be needed both before, during and after the wedding.

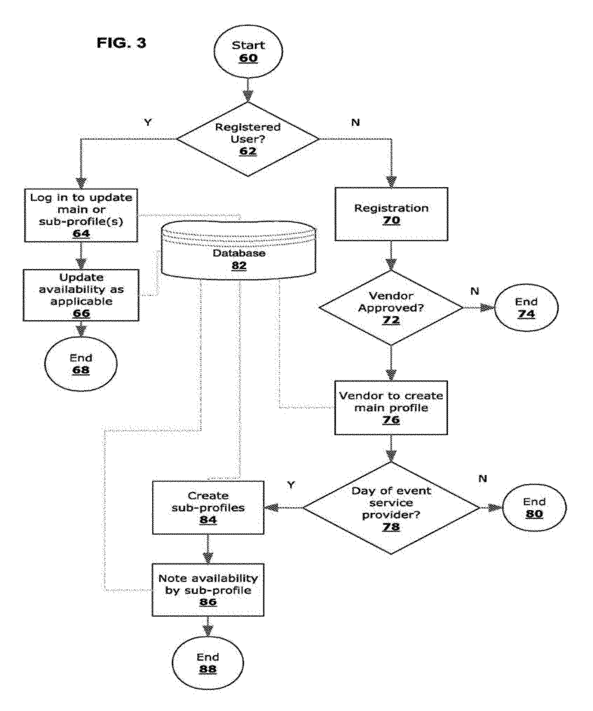

Referring now to the flowchart of FIG. 3, an event vendor 28 may visit the internet website 18 (step 60) and either log in to the system as a registered user (step 62) and make changes to existing profile (step 64) or add/delete availability by profile or sub-profile (step 66). All updated information will be saved to a database 10 (step 76). Alternatively, a vendor 28 that visits the website for the first time may register to become a service provider (step 70). The vendor 28 will be reviewed to determine whether they will be approved (step 72) and if a vendor 28 is not approved then the vendor 28 may not set up a profile (step 74).

If the vendor 28 is approved after a review (step 72) then the vendor 28 may proceed to create a main profile (step 76) which will include the type of business, main address, contact information, and other basic information. If the vendor 28 does not provide services on the actual day of the event, rather services related to the wedding or other event (step 78) then the vendor will not need to provide any other information (step 80) and profile information will be saved to database 10 (step 82). If the vendor 28 provides services on the actual day of the event (step 78), has been approved (step 72) and has also created a main profile (step 76), then the vendor 28 may create sub-profiles (step 84) to include but not limited to name of sub-profile, location, capacity (if vendor), and minimally acceptable amounts. Notably, the vendor posts their fee, which could be an hourly rate or fixed rate. Discounts and incentives may also be provided. Upon creation of the sub-profiles (step 84), the vendor 28 may then update availability of each sub-profile (step 86), profile information will be saved to database 10 (step 82), and process will end for the vendor (step 88).

Referring again to FIG. 2, after the bride 20 has completed and submitted an event form (step 42), the system may access vendor profiles (step 50) and generate a “dream vendor list” (step 52) matching the bride 20 with vendors that meet the planner's criteria, which may be saved in the bride's database (step 48). The bride or event planner 20 may then select one or more vendors 15 within one or more categories that the bride or event planner 20 would like to communicate with further (step 54). A notification will be sent to the selected vendors 15 to refer the bride or event planner 20 (step 58) and the bride or event planner 20 may then exit the system (step 60). In the event a bride or event planner 20 decides not to request any further information (step 54) then no other input will be required from the bride or event planner 20 (step 56) and the bride or event planner 20 may contact vendors on their own.

The terms “bride,” “event planner,” and “user” are synonymously used throughout this disclosure are referred to by reference numeral 20.

Referring to FIGS. 1-33, in a non-limiting exemplary embodiment, a system, method and/or computer program product provides an online wedding planning system for facilitating automatic matching, in real-time, of an event planner 20 with event vendors 28. In a preferred embodiment, the event planner 20 is a wedding event planner and the event vendors 28 are wedding event vendors. Reference numerals 220-244 illustrate various exemplary website screen shots that vendors 28 and event planners 20 employ for setting up, managing and benefiting from the functions of the present disclosure.

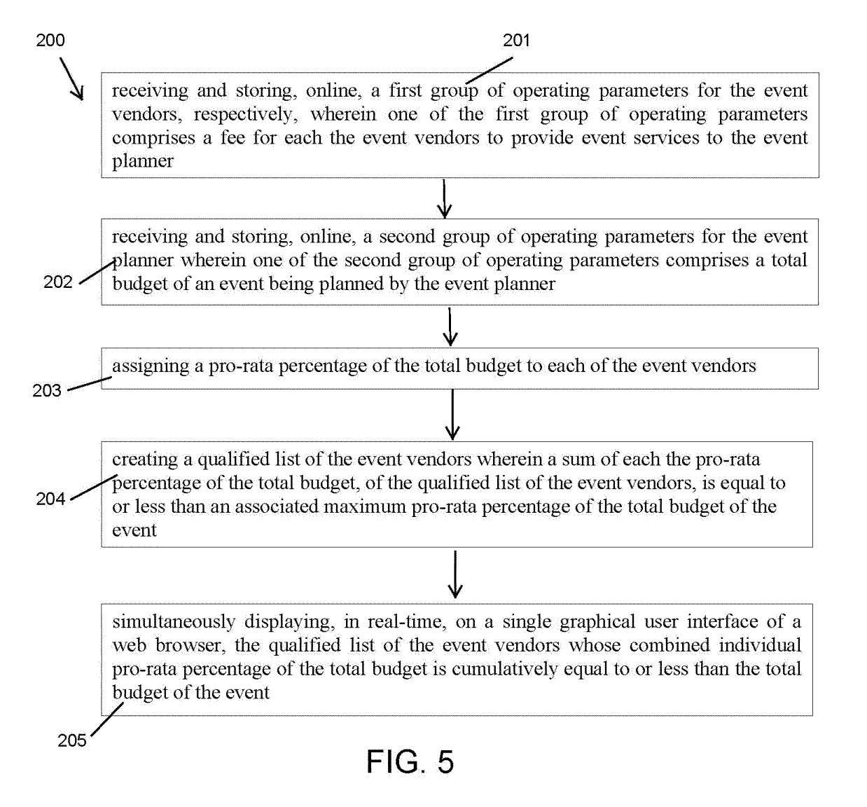

Referring to FIGS. 5-8, advantageous features provided by the present disclosure include a process 200 including an initial step 201 of receiving and storing, online, a first group of operating parameters 150 for the event vendors 28, respectively, wherein one of the first group of operating parameters 150 comprises a fee 151 for each of the event vendors 28 to provide event services to the event planner 20. Additionally, each event vendor 28 can include their qualifications and experiences, customer testimonials, pictures of their work, their location and service area, and at least one category of services offered by each the event vendor 28.

Next, at step 202, a second group of operating parameters 160 for the event planner 20 is received and stored, online, wherein one of the second group of operating parameters 160 includes a total budget 161 of an event being planned by the event planner 20. Then, at step 203, a pro-rata percentage 162 of the total budget 161 is assigned to each of the event vendors 28—as further explained hereinbelow.

In a non-limiting exemplary embodiment, at step 203a, an administrator of the online wedding planning system may assign a predefined pro-rata percentage 162 of the total budget 161 to each of the event vendors 28.

In a non-limiting exemplary embodiment, at step 203b, a user (e.g., event planner 20) may modify in real-time the predefined assignment 162 of the pro-rata percentage 162 of the total budget 161 to each of the events.

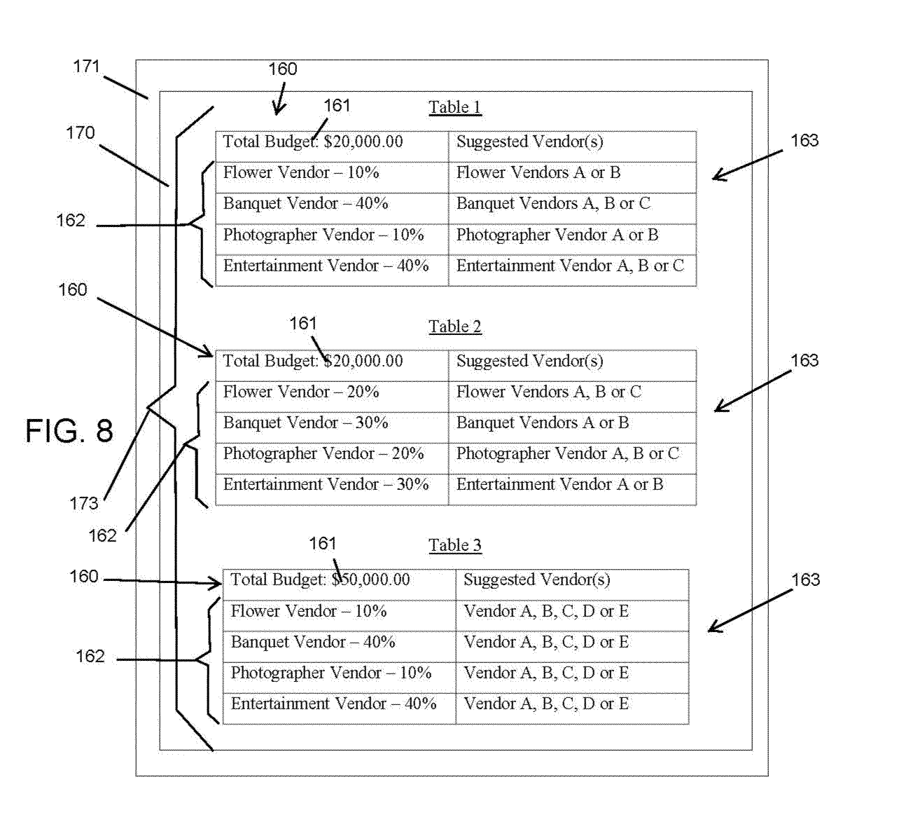

After assigning a pro-rata percentage 162 of the total budget 161 to each of the event vendors 28, step 204 provides a qualified list 163 of the event vendors 28 is created wherein a sum of each the pro-rata percentage 162 of the total budget 161, of the qualified list of the event vendors 28, is equal to or less than an associated maximum pro-rata percentage 162 of the total budget 161. The process continues to step 205 wherein a combined output 173 of the qualified list of the event vendors 28 is simultaneously displayed, in real-time, on a single graphical user interface 170 of a web browser 171, as perhaps best shown in FIG. 8. Notably, such a qualified list of event vendors 28 has a combined individual pro-rata percentage 162 of the total budget 161 that is cumulatively equal to or less than the total budget 161 of the event, ensuring that the event planner 20 does not go over budget. See FIG. 8 and tables 1-3 hereinbelow.

Referring to FIGS. 5-8, in a non-limiting exemplary embodiment, the bride 20 or event planner 20 may enter a total budget 161 for the entire event. The system will then provide suggested budgets for each type of vendor 28 (e.g., pro-rata vendor budget 162). For example, an administrator of the system may pre-assign 10% of the budget for flowers, 40% of the budget for the banquet location, 10% of the budget for the photographer, and 40% of the budget for live music. If the bride 20 or event planner 20 enters a $20,000.00 budget, the system will automatically suggest vendors 28 that can provide services for their pro-rata portion of the pre-assigned budget 162. Notably, a single GUI screen 170 is displayed on a web browser 171 displayed on a display screen of an electronic device. Such a single GUI screen 170 provides each vendor 28, their fees and availability, as based upon the maximum allocated budget for their services. In other words, if the flower vendor's 28 pro-rata budget is $2,000.00, the single GUI screen 170 displays all flower vendors 28 that can provide their service for no more than $2,000.00. The bride 20 or event planner 20 may then contact each vendor 28 to assist in making the final selection for the flower vendor 28. Of course, the bride 20 or event planner 20 may modify the pre-assigned vendor 28 budgets, as desired. In response, the system will suggest new vendors 28 that are affordable within the adjusted budget. See FIG. 8 and tables 1-3 hereinbelow.

In a non-limiting exemplary embodiment, the system will automatically generate/transmit a message to each vendor 28 who falls outside the event planner's 20 allocated budget. The message asks the vendor 28 whether they wish to reduce their fees to qualify under the event planner's 20 total budget. If the vendor 28 says yes, the event planner 20 is notified and the vendor 28 is added to the list of qualified vendors.

The tables below list non-limiting exemplary outputs of vendor 28 lists based on the total budget 161 input as well as pre-assigned pro-rata vendor budgets 162.

TABLE 1

| Total Budget: $20,000.00 | Suggested Vendor(s) |
|---|---|
| Flower Vendor - 10% | Flower Vendors A or B |
| Banquet Vendor - 40% | Banquet Vendors A, B or C |
| Photographer Vendor - 10% | Photographer Vendor A or B |
| Entertainment Vendor - 40% | Entertainment Vendor A, B or C |

TABLE 2

| Total Budget: $20,000.00 | Suggested Vendor(s) |
|---|---|
| Flower Vendor - 20% | Flower Vendors A, B or C |
| Banquet Vendor - 30% | Banquet Vendors A or B |
| Photographer Vendor - 20% | Photographer Vendor A, B or C |
| Entertainment Vendor - 30% | Entertainment Vendor A or B |

TABLE 3

| Total Budget: $50,000.00 | Suggested Vendor(s) |
|---|---|
| Flower Vendor - 10% | Vendor A, B, C, D or E |
| Banquet Vendor - 40% | Vendor A, B, C, D or E |
| Photographer Vendor - 10% | Vendor A, B, C, D or E |
| Entertainment Vendor - 40% | Vendor A, B, C, D or E |

Furthermore, the system evaluates when a vendor 28 is available and whether such a vendor 28 is located in the geographic region of the bride 20 or event planner 20. Other factors that may be reviewed are vendor experience, vendor specialty, etc. After the initial suggested vendor list is generated, the event planner 20 can modify the parameters to generate new vendors 28 or can contact the vendors 28 directly for more information.

In a non-limiting exemplary embodiment, individual budgets may also be entered for all wedding day categories.

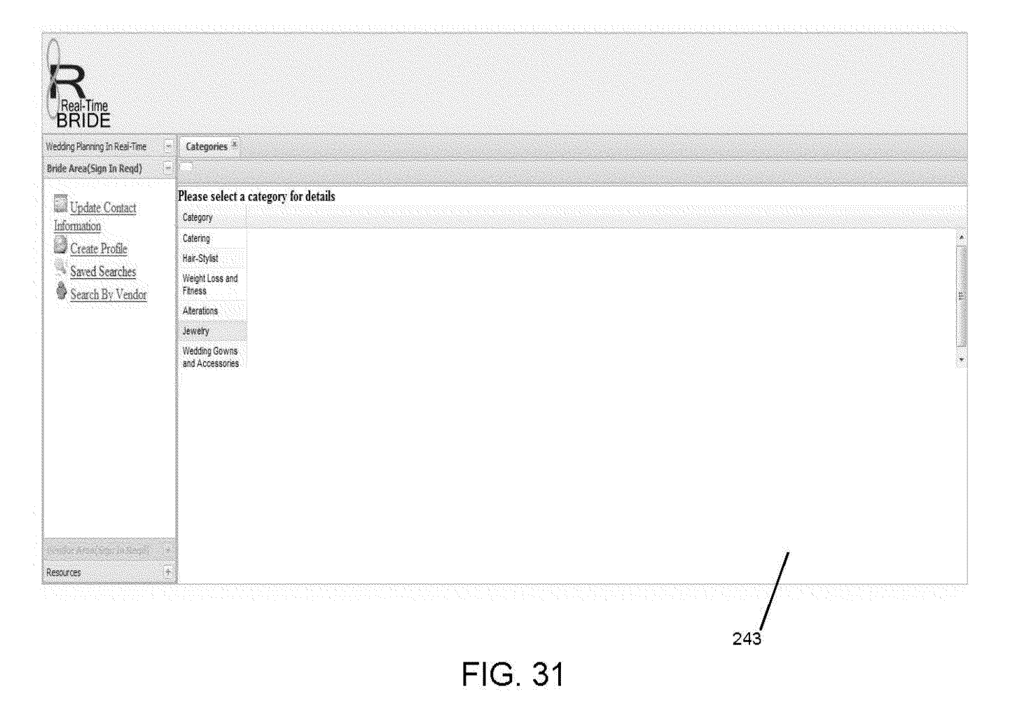

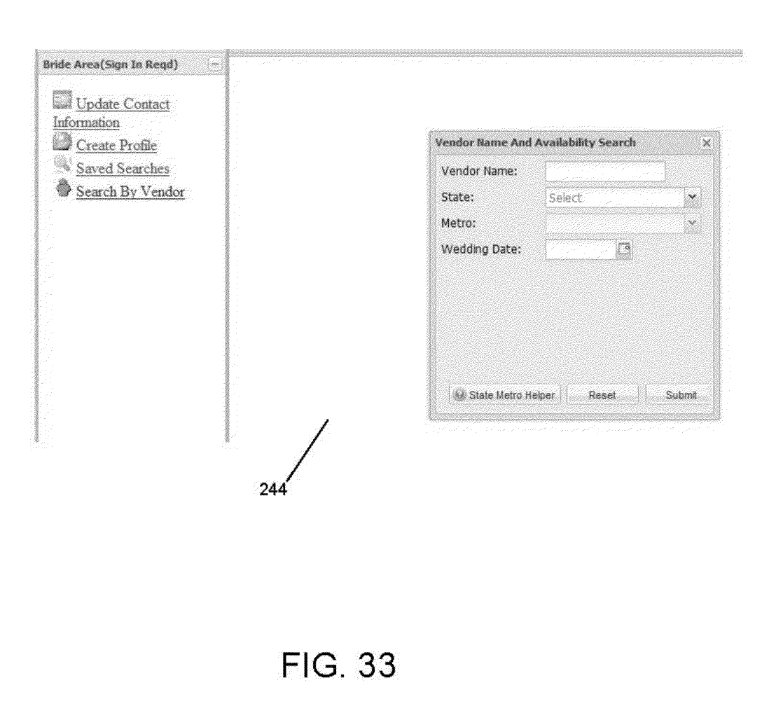

In a non-limiting exemplary embodiment, as perhaps best shown in FIGS. 31, 33, a variety of wedding industry categories may be viewed in one search.

In a non-limiting exemplary embodiment, as perhaps best shown in FIGS. 31, 33, different tabs show categories selected in a user-generated form (or pre-defined form). Thus, the bride 20 can click on each tab to find vendors 28.

In a non-limiting exemplary embodiment, FIG. 33, the user (e.g., event planner 20, bride 20) can search vendors 28 by their name. This gives brides 20 an opportunity to quickly look up a vendor in a category by name, and can be used for mobile devices as well as on a PC, laptop, desktop etc.

In a non-limiting exemplary embodiment, a budget recommendation tool is provided for assisting the user to create a budget 161 for the event. If a bride 20 or event planner 20 does not yet know the budget 161, he/she can find vendors 28 in pre-established budget 162 categories. For example, if the user wants to see a wedding budget 161 of $10,000.00, and then a $15,000.00 vs. $20,000.00 wedding budgets, the system displays the vendors 28 that fall specifically in that category. A vendor 28 can show up in multiple price points (e.g., multiple wedding budgets 161) based on how they have set pricing for their sub-profile.

In a non-limiting exemplary embodiment, an event booking function is provided wherein each vendor 28 sub-profile is customized to indicate the number of bookings it can accept per day. In this manner, the vendor 28 can then “reserve” one or multiple slots by bridal party, # of guests, or other relevant information in its sub-profile. Vendor 28 availability is shown if the vendor's 28 time slots are available. Vendor 28 availability is not shown when the vendor's 28 time slots are not available.

In a non-limiting exemplary embodiment, a full event management function is provided wherein vendors 28 enter relevant information such as amount paid, amount due, etc. and use the system to auto generate reminders for various reasons (e.g., remind the bride 20 or event planner 20 that a balance is due on the account).

In a non-limiting exemplary embodiment, multi-location searches can are performed if a bride 20 is undecided on an final location of the wedding event, but has a date in mind. In this manner, the bride 20 or planner can simultaneously search the same information in multiple locations. For example, if a bride 20 is not sure on location 1 vs. location 2 vs. location 3, she can simultaneously search the same desired categories in all three locations. Then, she can click on the location tab in the search results to find the results for each location.

It should be understood, of course, that the foregoing relates to exemplary embodiments of the disclosure and that modifications may be made without departing from the spirit and scope of the disclosure as set forth in the following claims.

While the disclosure has been described with respect to a certain specific embodiment, it will be appreciated that many modifications and changes may be made by those skilled in the art without departing from the spirit of the disclosure. It is intended, therefore, by the appended claims to cover all such modifications and changes as fall within the true spirit and scope of the disclosure. In particular, with respect to the above description, it is to be realized that the optimum dimensional relationships for the parts of the present disclosure may include variations in size, materials, shape, form, function and manner of operation.

What is claimed as new and what is desired to secure by Letters Patent of the United States is:

1. A method for facilitating an online planning system that automatically matches, in real-time, an event planner with event vendors, said method comprising the steps of:
receiving and storing, online, a first group of operating parameters for said event vendors, respectively, wherein one of said first group of operating parameters comprises a fee for each said event vendors to provide event services to said event planner;
receiving and storing, online, a second group of operating parameters for said event planner wherein one of said second group of operating parameters comprises a total budget of an event being planned by said event planner;
assigning a pro-rata percentage of said total budget to each of said event vendors;
creating a qualified list of said event vendors wherein a sum of each said pro-rata percentage of said total budget, of said qualified list of said event vendors, is equal to or less than an associated maximum pro-rata percentage of said total budget of said event; and
simultaneously displaying, in real-time, on a single graphical user interface of a web browser, said qualified list of said event vendors whose combined individual pro-rata percentage of said total budget is cumulatively equal to or less than said total budget of said event.

2. The method of claim 1, wherein said event planner is a wedding event planner.

3. The method of claim 2, wherein said event vendor is a wedding event vendor.

4. The method of claim 3, wherein said step of assigning a pro-rata percentage of said total budget to each of said event vendors is predefined by an administrator of said online planning system.

5. The method of claim 4, wherein said step of assigning a pro-rata percentage of said total budget to each of said event vendors is modified in real-time by said event planner.

6. The method of claim 5, wherein said first group of operating parameters further comprises: a location of each said wedding event vendor, and at least one category of services offered by each said wedding event vendor.

7. An online planning system for facilitating automatic matching, in real-time, of an event planner with event vendors, said online planning system comprising:
means for receiving and storing, online, a first group of operating parameters for said event vendors, respectively, wherein one of said first group of operating parameters comprises a fee for each said event vendors to provide event services to said event planner;
means for receiving and storing, online, a second group of operating parameters for said event planner wherein one of said second group of operating parameters comprises a total budget of an event being planned by said event planner;
means for assigning a pro-rata percentage of said total budget to each of said event vendors;
means for creating a qualified list of said event vendors wherein a sum of each said pro-rata percentage of said total budget, of said qualified list of said event vendors, is equal to or less than an associated maximum pro-rata percentage of said total budget; and
means for simultaneously displaying, in real-time, on a single graphical user interface of a web browser, said qualified list of said event vendors whose combined individual pro-rata percentage of said total budget is cumulatively equal to or less than said total budget of said event.

8. The online planning system of claim 7, wherein said event planner is a wedding event planner.

9. The online planning system of claim 8, wherein said event vendor is a wedding event vendor.

10. The online planning system of claim 9, wherein said means for assigning a pro-rata percentage of said total budget to each of said wedding event vendors is predefined by an administrator of said online planning system.

11. The online planning system of claim 10, wherein said means for assigning a pro-rata percentage of said total budget to each of said wedding event vendors is modified in real-time by said event planner.

12. The online planning system of claim 11, wherein said first group of operating parameters further comprises: a location of each said wedding event vendor, and at least one category of services offered by each said wedding event vendor.

13. A computer program product comprising a computer usable medium encoded in a computer having control logic stored therein for causing the computer to facilitate an online planning system that automatically matches, in real-time, an event planner with event vendors, said control logic comprising:
first computer readable program code means for causing the computer to receive and store, online, a first group of operating parameters for said event vendors, respectively, wherein one of said first group of operating parameters comprises a fee for said event vendor to provide event services to said event planner;
second computer readable program code means for causing the computer to receive and store, online, a second group of operating parameters for said event planner wherein one of said second group of operating parameters comprises a total budget of an event being planned by said event planner;
third computer readable program code means for causing the computer to assign a pro-rata percentage of said total budget to each of said event vendors;
fourth computer readable program code means for causing the computer to create a qualified list of said event vendors wherein a sum of each said pro-rata percentage of said total budget, of said qualified list of said event vendors, is equal to or less than an associated maximum pro-rata percentage of said total budget; and
fifth computer readable program code means for causing the computer to simultaneously display, in real-time, on a single graphical user interface of a web browser, said qualified list of said event vendors whose combined individual pro-rata percentage of said total budget is cumulatively equal to or less than said total budget of said event.

14. The control logic of claim 13, wherein said event planner is a wedding event planner.

15. The control logic of claim 14, wherein said event vendor is a wedding event vendor.

16. The control logic of claim 15, wherein said third computer readable program code means for causing the computer to assign a pro-rata percentage of said total budget to each of said wedding event vendors is predefined by an administrator of said online planning system.

17. The control logic of claim 16, wherein said third computer readable program code means for causing the computer to assign a pro-rata percentage of said total budget to each of said wedding event vendors is modified in real-time by said event planner.

18. The control logic of claim 17, wherein said first group of operating parameters further comprises: a location of each said wedding event vendor, and at least one category of services offered by each said wedding event vendor.
